(19) United States
(12) Patent Application Publication
(10) Pub. No.: US 2026/0010720 A1
(43) Pub. Date: Jan. 8, 2026

(54) SEGMENTING TEXT USING MACHINE LEARNING MODELS

(71) Applicant: X Development LLC, Mountain View, CA (US)

(72) Inventors: Irhum Shafkat, San Francisco, CA (US); Garrett Raymond Honke, Mountain View, CA (US)

(21) Appl. No.: 18/764,616

(22) Filed: Jul. 5, 2024

(51) Int. Cl. G06F 40/284; G06F 16/33; G06F 16/34; G06F 40/205

(52) U.S. Cl. CPC G06F 40/284; G06F 16/3344; G06F 16/345; G06F 40/205

(57) ABSTRACT

Methods, systems, and apparatus, including computer programs encoded on computer storage media, for determining segments from a sequence of text. One of the methods includes obtaining data representing a sequence of text; dividing the sequence of text into a plurality of sentence fragments; determining classification scores comprising determining a classification score using a machine learning model for each of a plurality of pairs of sentence fragments formed from the plurality of sentence fragments; assigning one or more split positions based on the classification scores; and combining the plurality of sentence fragments back into at least two segments, with a boundary of at least one of the at least two segments being identified by one of the one or more split positions, and wherein each segment comprises one or more sentence fragments.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for determining segments from a given sequence of text. For example, the system can determine segments in the sequence of text using one or more machine learning models.

In general, one innovative aspect of the subject matter described in this specification can be embodied in methods that include the actions of obtaining data representing a sequence of text; dividing the sequence of text into a plurality of sentence fragments; determining classification scores comprising determining a classification score using a machine learning model for each of a plurality of pairs of sentence fragments formed from the plurality of sentence fragments; assigning one or more split positions based on the classification scores; and combining the plurality of sentence fragments back into at least two segments, with a boundary of at least one of the at least two segments being identified by one of the one or more split positions, and wherein each segment comprises one or more sentence fragments.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on its software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

In some implementations, the sequence of text represents one or more legal documents.

In some implementations, obtaining data representing a sequence of text comprises receiving the data from a user.

In some implementations, the method further comprises providing the at least two segments to a user.

In some implementations, the method further comprises: receiving a query from a user; identifying one or more relevant segments from the at least two segments; and providing the one or more identified relevant segments to the user.

In some implementations, dividing the text into a plurality of sentence fragments comprises providing the sequence of text as input to a model that is configured to generate a plurality of sentence fragments given an input sequence of text.

In some implementations, determining a classification score using a machine learning model for each of a plurality of pairs of sentence fragments formed from the plurality of sentence fragments comprises: for each pair of sentence fragments, determining the classification score for the pair of sentence fragments by providing data representing the pair of sentence fragments to the machine learning model, wherein the machine learning model is configured to generate a classification score representing a likelihood that an input pair of sentence fragments are not similar.

In some implementations, assigning one or more split positions based on the classification scores comprises determining one or more split positions that each reflect a highest likelihood that two sentence fragments in a particular pair of sentence fragments are not similar among the plurality of pairs of sentence fragments.

In some implementations, the one or more split positions that each reflect a highest likelihood that two sentence fragments in a particular pair of sentence fragments are not similar have a highest classification score among the plurality of pairs of sentence fragments.

In some implementations, assigning one or more split positions based on the classification scores comprises assigning one or more split positions based on a current set of classification scores at each of a plurality of iterations, and wherein the method comprises, at each iteration: determining that a termination condition has not been met; in response to determining that the termination condition has not been met, assigning a split position corresponding to an index for a pair of sentence fragments with a highest classification score in the current set of classification scores; modifying the current set of classification scores by setting the highest classification score to zero; identifying a first set of sentence fragments comprising one or more sentence fragments of the plurality of sentence fragments preceding the split position; identifying a second set of sentence fragments comprising one or more sentence fragments of the plurality of sentence fragments following the split position; for each set of the first set and second set: identifying a respective subset of sentence fragments in the set; modifying the current set of classification scores by setting one or more of the classification scores for the pairs of sentence fragments in the respective subset to zero; and updating the current set of classification scores to the classification scores for the sentence fragments of the set.

In some implementations, the respective subset of sentence fragments comprises a cumulative number of tokens greater than or equal to a threshold number of tokens.

In some implementations, the termination condition is defined by a condition where all of the classification scores are zero.

In some implementations, the machine learning model has been trained by a training system on training data, wherein the training data comprises a plurality of training examples, each comprising a training input comprising two sentence fragments and a training output comprising a label based on a user input indicating whether the two sentence fragments are similar.

In some implementations, the two sentence fragments are nonconsecutive sentence fragments.

In some implementations, the two sentence fragments are obtained from the sequence of text.

In some implementations, the machine learning model comprises a language model that has been fine-tuned on training data comprising a plurality of training examples, wherein each training example comprises an input prompt comprising a pair of sentence fragments and a target answer for the pair of sentence fragments.

In some implementations, the machine learning model comprises a classifier model.

In some implementations, the classifier model has been trained on training data comprising labeled pairs of labeled sentence fragments, wherein each pair comprises a label representing whether a first sentence fragment of the pair is similar to a second sentence fragment of the pair.

In some implementations, the method further comprises generating a mapping of an identifier for each of the at least two segments to a corresponding location of the segment within the sequence of text.

In some implementations, the method further comprises generating a summary for each of the at least two segments.

Particular embodiments of the subject matter described in this specification can be implemented to realize one or more of the following advantages.

Machine learning models such as large language models can perform a variety of tasks with input text. However, large language models have a finite context window (e.g., hundreds or thousands of tokens) and can process a limited amount of text at a time (e.g., less than 1,000 tokens, less than 5,000 tokens, less than 10,000 tokens, or less than 20,000 tokens), and may require that a long sequence of text be split into segments for processing. Conventional systems for separating text may separate text into segments based on rules that result in segments that are not semantically meaningful. Providing these segments as input to a large language model may lead to suboptimal processing results. Furthermore, a sequence of text that fits within the context window may include multiple topics. Providing the entire sequence of text as input to a large language model may also lead to suboptimal processing results. The system described in this specification can automate the identification and separation of text into semantically meaningful segments for processing by downstream processing systems such as large language models.

Conventional systems for separating text may separate text into segments that are not semantically meaningful. For example, conventional systems may split text into segments of fixed token length such as a fixed number of characters, subwords, or words. These segments may include sentences or ideas that have been cut off. These segments may also include text relating to more than one topic. Some conventional systems may split text based on particular characters such as punctuation or newline characters. For example, splitting based on punctuation may result in text relating to one topic being separated among multiple segments. As another example, splitting on punctuation may result in unintelligible segments, particularly for citations such as legal citations. Splitting on newline characters may result in long segments that include multiple topics, or that require further splitting for downstream processing.

In some examples, the given sequence of text can be a document with document tags. Conventional systems may identify each child node as a segment. However, these systems are limited to documents with document tags, and tagging the documents can be time-consuming. In addition, each of these segments may not include enough information for downstream processing.

The system can identify and generate segments or sections of a document, where each segment or section is self-contained. That is, each segment includes semantically relevant content, or content that relates to the same topic. For example, the system can divide the given sequence of text into sentence fragments and determine classification scores for each pair of sentence fragments using a machine learning model. The system can assign split positions based on the classification scores. The system can then combine the sentence fragments into segments whose boundaries are defined by the split positions. Providing semantically relevant and self-contained segments as input to a large language model can lead to improved processing results over providing a sequence of text that includes multiple topics as input to the large language model. For example, the large language model can generate an output for a similarity-based retrieval task that is more useful when processing a semantically relevant and self-contained segment compared to the output when processing a sequence of text with multiple topics.

In addition, the system can automate the identification and generation of self-contained segments of a document. For example, by assigning split positions based on classification scores, the system can identify and generate self-contained segments for large documents, and for large numbers of large documents. The system can also identify and generate self-contained segments consistently.

The system can determine classification scores using a machine learning model that has been trained to generate a classification score that captures how much two input sentence fragments are relevant or about the same topic. The machine learning model can have been trained on training data that includes a small amount of labeled data (e.g., hundreds or thousands of training examples). For example, the system can obtain labels for pairs of sentences from a document that indicate whether the sentences are “similar” or “different.” The pairs of sentences can be sampled from the document. In some examples, the system can obtain the labels from a user, allowing the system to learn user preferences. The system can leverage the labeling to train the machine learning model to break entire documents. Because the training data includes high-quality labels for semantically related content, the machine learning model can be trained on a smaller amount of data, which saves computing time and resources during training and during the generation of the training data.

The system also generates segments that are semantically related with improved accuracy (e.g., by 10%) when using a machine learning model to determine classification scores as described in this specification, compared to using a machine learning model that has been trained in an unsupervised manner and semantics-unaware chunking (i.e., using a fixed token length).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for determining segments of text.

FIG. 2 is a flow diagram of an example process for determining segments of text.

FIG. 3 is a flow chart of an example process for determining segments of text.

FIG. 4 is a flow chart of an example process for assigning split positions.

FIG. 5 depicts a schematic diagram of a computer system that may be applied to any of the computer-implemented methods and other techniques described herein.

Like reference numbers and designations in the various drawings indicate like elements.

### DETAILED DESCRIPTION

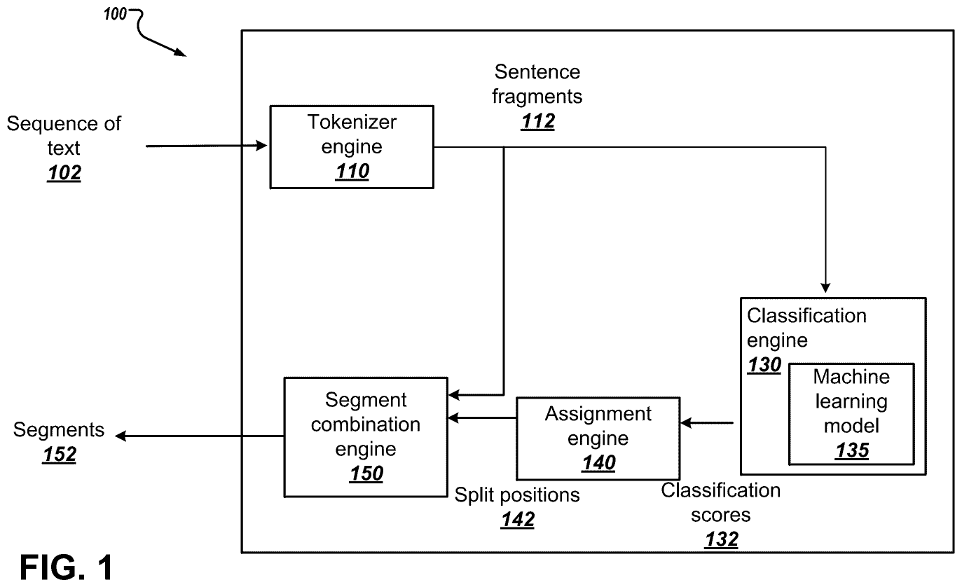

FIG. 1 shows an example system 100 for determining segments of text. The system 100 is an example of a system implemented as computer programs on one or more computers in one or more locations. The system 100 can include a tokenizer engine 110, a classification engine 130, an assignment engine 140, and a segment combination engine 150. In some implementations, the components can be part of a same system and/or network of computing devices and/or systems.

The tokenizer engine 110 can be any appropriate computing system that is configured to divide a given sequence of text into sentence fragments. Each sentence fragment can include at least part of a sentence. For example, the tokenizer engine 110 can generate sentence fragments 112 from the sequence of text 102. As an example, the tokenizer engine 110 can be a T5 tokenizer, a spaCy tokenizer, or an NLTK tokenizer.

The sequence of text 102 can include one or more documents. For example, the one or more documents can include legal documents such as contracts, court cases, and/or court transcripts. Although this specification can be applied to sequences of text that include legal documents, the system 100 can be used to generate segments for many types of sequences of text such as general business documents.

The classification engine 130 can be any appropriate computing system that is configured to generate classification scores. Each classification score can correspond to a pair of consecutive sentence fragments and can represent a similarity between the two consecutive sentence fragments. For example, the classification score can represent the likelihood that an input pair of sentence fragments are not similar, that is, the likelihood that the input pair of sentence fragments belong to different segments. Each classification score can have a corresponding identifier, for example, that identifies the corresponding pair of sentence fragments.

The classification engine 130 can include a machine learning model 135. The classification engine 130 can generate classification scores 132 for the sentence fragments 112 by processing the sentence fragments 112 using the machine learning model 135. The machine learning model 135 can be configured to generate a classification score representing a likelihood that an input pair of sentence fragments are not similar. As an example, the machine learning model 135 can be a classifier. For example, the classifier can output a single unit activated based on a confidence that the input pair of sentence fragments are not similar. The machine learning model 135 can have any appropriate architecture for generating a classification score representing a likelihood that an input pair of sentence fragments are not similar. For example, the machine learning model 135 can be a multilayer perceptron (MLP).

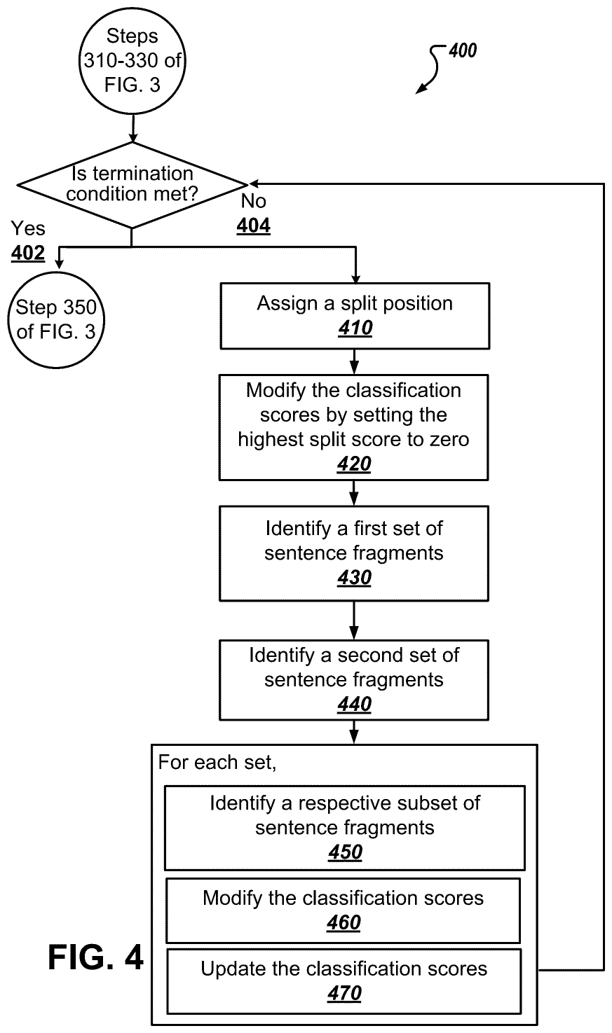

The assignment engine 140 can be any appropriate computing system that is configured to assign split positions based on classification scores. Each split position can correspond to a classification score and can represent that the sentence fragments that correspond to the classification score should belong to different segments. For example, the assignment engine 140 can identify split positions 142 based on the classification scores 132. Assigning split positions based on classification scores is described in more detail below with reference to FIG. 4.

The segment combination engine 150 can be any appropriate computing system that is configured to determine segments given sentence fragments and split positions. For example, the segment combination engine 150 can generate segments 152 that each include one or more sentence fragments 112. The boundaries of the segments 152 can be defined by one or more of the split positions 142.

As an example, the system 100 can obtain a sequence of text 102. The system 100 can use the tokenizer engine 110 to divide the sequence of text 102 into multiple sentence fragments 112. The system can use the classification engine 130 to determine a classification score for each pair of sentence fragments in sentence fragments 112. The system 100 can use the assignment engine 140 to assign split positions based on the classification scores 132. The system 100 can provide the split positions 142 and the sentence fragments 112 to the segment combination engine 150 to generate the segments 152. The system 100 can output the segments 152.

In some implementations, the system 100 can include a user interface. The user interface can be configured to allow a user to interact with the system 100. For example, the user interface can allow a user to input a sequence of text 102 and receive data representing one or more of the segments 152 from the system 100.

In some implementations, the system 100 can include one or more language model neural networks, also referred to as language models. For example, the system 100 can provide the segments 152 to the one or more language models to process the segments 152. For example, the system can use a large language model to generate summaries of each of the segments 152. The system can perform further processing, such as classifying each segment based on the corresponding summary, and generating documents using the classified segments.

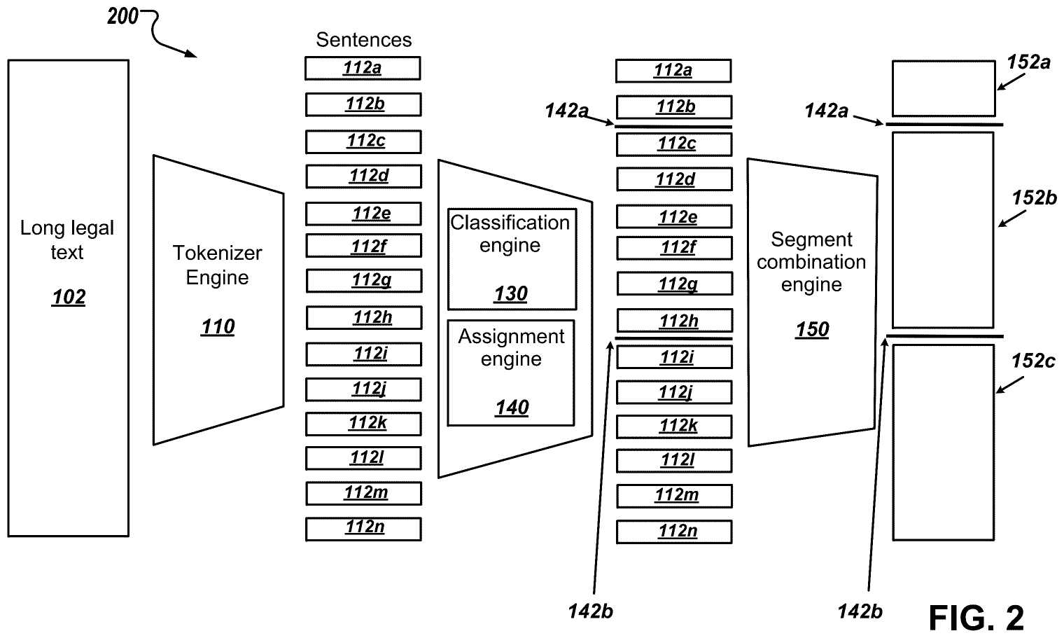

FIG. 2 is a flow diagram of an example process 200 for determining segments of text. The process 200 can be performed by a system such as the system 100, for example.

The system provides a sequence of text 102 as input to the tokenizer engine 110. In the example of FIG. 2, the sequence of text 102 is a long legal text. For example, the long legal text can include a court transcript or written opinion of more than 5 pages, more than 10 pages, more than 20 pages, or more than 50 pages of text (e.g., double-spaced text).

The tokenizer engine 110 can process the sequence of text 102 to generate sentence fragments 112. In some examples, a sentence fragment can include a full sentence. In some examples, the sentence fragment can include part of a sentence. In the example of FIG. 2, the sentence fragments include sentence fragments 112a-n.

The system processes the sentence fragments 112 to determine split positions 142. The system can use the classification engine 130 and the assignment engine 140 to determine the split positions 142. For example, the classification engine 130 can process the sentence fragments 112 to determine a classification score for each pair of sentence fragments. For example, the classification engine 130 can determine a classification score for sentence fragments 112a and 112b, and a classification score for sentence fragments 112b and 112c, etc. The assignment engine 140 can assign split positions based on the classification scores. In the example of FIG. 2, there are two split positions, 142a and 142b, for the sentence fragments 112. For example, the classification score for sentence fragments 112b and 112c, and the classification score for sentence fragments 112h and 112i, can be the highest classification scores.

The system provides the split positions 142 to the segment combination engine 150. The segmentation combination engine 150 generates segments 152. In the example of FIG. 2, the segment combination engine 150 outputs three segments 152a-c. Each segment includes one or more sentence fragments. The boundary of each segment is defined by the split positions. For example, segment 152a can include sentence fragments 112a-b, with the ending boundary identified by the split position 142a. Segment 152b can include sentence fragments 112c-h, with the starting boundary identified by the split position 142a and the ending boundary identified by the split position 142b. Segment 152c can include sentence fragments 112i-n, with the starting boundary identified by the split position 142b.

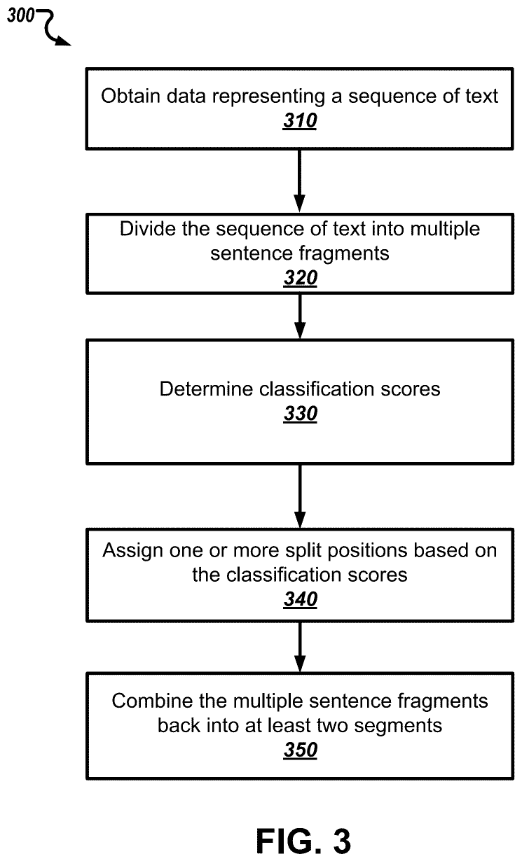

FIG. 3 is a flow chart of an example process 300 for determining segments of text. For convenience, the process 300 will be described as being performed by a system of one or more computers located in one or more locations. For example, a system for determining segments of text, e.g., the system 100 of FIG. 1, appropriately programmed in accordance with this specification, can perform the process 300.

The system obtains data representing a sequence of text (step 310). For example, the sequence of text can represent one or more legal documents. In some implementations, the system can obtain data representing a sequence of text by receiving the data from a user. For example, the system can receive the data as part of a query from the user about the sequence of text.

The system divides the sequence of text into multiple sentence fragments (step 320). For example, the system can provide the sequence of text as input to a model that is configured to generate multiple sentence fragments given an input sequence of text. The model can be the tokenizer engine 110 described above with reference to FIG. 1, for example.

The system determines classification scores (step 330). For example, the system can determine a classification score for each of multiple pairs of sentence fragments formed from the multiple sentence fragments. Each of the pairs of sentence fragments can include two consecutive sentence fragments from the multiple sentence fragments. Each classification score can correspond to a pair of consecutive sentence fragments and can represent a likelihood that the pair of consecutive sentence fragments are not similar. For example, the classification score can represent a likelihood that the pair of sentence fragments are not related, or a likelihood that the pair of sentence fragments belong to different segments.

The system can determine classification scores using a machine learning model. For example, the machine learning model can be configured to generate a classification score representing a likelihood that an input pair of sentence fragments are not similar. The system can determine classification scores for each pair of sentence fragments by providing data representing each pair of sentence fragments to the machine learning model.

In some implementations, the system can determine classification scores for each pair of sentence fragments by combining classification scores for other pairs of sentence fragments. For example, for each pair of sentence fragments, the system can determine a first classification score between the two sentence fragments in the pair of sentence fragments by providing the pair of sentence fragments to the machine learning model. For example, referring to FIG. 2, if the pair of sentence fragments includes sentence fragment 112d and sentence fragment 112e, the first classification score can be the classification score for sentence fragment 112d and sentence fragment 112e.

The system can also determine one or more second classification scores. Each of the one or more second classification scores can be determined for two sentence fragments in the multiple sentence fragments. For example, one of the second classification scores can be the classification score for the first sentence fragment in the pair of sentence fragments, and the sentence fragment following the second sentence fragment in the pair of sentence fragments. For example, referring to FIG. 2, the second classification score can be the classification score for sentence fragment 112d and sentence fragment 112f. As another example, another of the second classification scores can be the second classification score for the second sentence fragment in the pair of sentence fragments, and the sentence fragment preceding the first sentence fragment in the pair of sentence fragments. For example, referring to FIG. 2, the second classification score can be the classification score for sentence fragment 112c and sentence fragment 112e.

The system can determine the classification score for the pair by combining the first classification score and the one or more second classification scores. For example, the system can determine the classification score for the pair of sentence fragments 112d and 112e by combining the classification score for sentence fragments 112d and 112e, sentence fragments 112d and 112f, and sentence fragments 112c and 112e. For example, the system can compute a weighted sum of the first classification score and the one or more second classification scores. For example, the first classification score can be weighted by a factor of 0.5, and each of the second classification scores can be weighted by a factor of 0.25.

In some implementations, the machine learning model can have been trained by a training system of the system on training data. The training data can include multiple training examples that each include a training input and a training output. The training input can include two sentence fragments. The training output can include a label indicating whether the two sentence fragments are similar. For example, the label can include “yes” or “no,” or a classification score.

In some implementations, the two sentence fragments of the training input are nonconsecutive sentence fragments. For example, the two sentence fragments can have been sampled from a sequence of text.

In some implementations, the training system can generate the training examples. For example, the training system can derive the labels based on user input. For example, the training system can sample pairs of sentence fragments from a sequence of text for training. The training system can provide the pairs of sentence fragments for presentation to a user. The training system can receive an input from the user that indicates whether the pair of sentence fragments are similar. The training system can generate a training example for each of the inputs received from the user. For example, the training input can include the pair of sentence fragments provided for presentation to the user, and the label of the training output can include the input from the user.

As another example, the user input can indicate segments from a sequence of text for training. For example, the training system can provide a sequence of text for training for presentation to a user. The training system can receive an input from the user that indicates potential segments. The training system can generate a training example for each of the pairs of sentence fragments within each potential segment. For example, the training input can include a pair of sentence fragments within the potential segment, and the label of the training output can indicate that the two sentence fragments are similar. As another example, the training input can include a last sentence fragment from the potential segment and a sentence fragment that follows the last sentence fragment, and the label of the training output can indicate that the two sentence fragments are not similar.

In some implementations, the machine learning model can be trained on training data representative of the sequence of text that the system obtains for segmenting. For example, the two sentence fragments of each training input can have been obtained from the sequence of text.

In some implementations, the machine learning model can include a classifier model. The classifier model can be configured to generate a probability distribution over possible classes given data representing a pair of sentence fragments. The probability distribution can include, for example, the probability that the pair of sentence fragments belong to the same segment, and the probability that the pair of sentence fragments do not belong to the same segment. The data representing the pair of sentence fragments can include features of the sentence fragments. For example, the system can obtain features for each pair of sentence fragments and provide the features to the classifier model as input. In some implementations, the classifier model can be a random forest model.

For example, the features can include embeddings of each of the sentence fragments. An “embedding,” as used in this specification is a vector of numeric values, e.g., floating point or other type of numeric values, that has a predetermined dimensionality, e.g., has a predetermined number of values. For example, the system can use an embedding model to generate embeddings of each of the sentence fragments. As an example, the embedding model can be a Transformer-based model such as Sentence-T5. In some implementations, the embedding model can be finetuned on training data for a particular domain, such as the legal domain.

In some examples, the system can perform term frequency-inverse document frequency (tf-idf) or singular value decomposition (SVD) operations to obtain features. In some examples, the system can use bi-grams, tri-grams, or quadrigrams derived from each pair of sentence fragments as features for input to the classifier model.

The classifier model can output the probability that the pair of sentence fragments belong to the same segment and the probability that the pair of sentence fragments do not belong to the same segment. The system can use the probability that the pair of sentence fragments do not belong to the same segment as the classification score.

The classifier model can have been trained on training data that includes labeled pairs of sentence fragments. For example, each pair can include a label representing whether a first sentence fragment of the pair is similar to a second sentence fragment of the pair. For example, the labels can include “yes” or “no.” The labels can have been obtained from a user, for example, as described above. Each pair can also include data representing the first sentence fragment and the second sentence fragment. For example, the data can include features for the first sentence fragment and the second sentence fragment.

In some implementations, the machine learning model can include a language model neural network. The language model can generate an output that identifies whether two input sentence fragments are similar. For example, for each pair of sentence fragments, the system can provide data representing the two sentence fragments to the language model. The data representing the two sentence fragments can include an input prompt that includes the two sentence fragments. For each pair of sentence fragments, the system can use the language model to generate a prediction that the two sentence fragments belong to the same segment.

The language model can have any appropriate neural network architecture that allows the language model to map an input sequence of text tokens from a vocabulary to an output sequence of text tokens from the vocabulary.

For example, the language model can have a Transformer-based architecture. In general a Transformer-based architecture can be one which is characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used.

In particular, the language model can be an auto-regressive neural network that auto-regressively generates the output sequence of text tokens by generating each particular text token in the output sequence conditioned on a current input sequence that includes (i) the input sequence followed by (ii) any text tokens that precede the particular text token in the output sequence.

More specifically, to generate a particular text token, the language model can process the current input sequence to generate a score distribution, e.g., a probability distribution, that assigns a respective score, e.g., a respective probability, to each token in the vocabulary of text tokens. The language model can then select, as the particular text token, a text token from the vocabulary using the score distribution. For example, the language model can greedily select the highest-scoring token or can sample, e.g., using top-k sampling, nucleus sampling or another sampling technique, a token from the distribution.

As a particular example, the language model can be an auto-regressive Transformer-based neural network that includes a plurality of layers that each apply a self-attention operation. The language model can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

The tokens in the vocabulary can be any appropriate text tokens, e.g., words, word pieces, punctuation marks, characters, bytes, and so on that represent elements of text in one or more natural languages and, optionally, numbers and other text symbols that are found in a corpus of text. For example, the system can tokenize a given sequence of words by applying a tokenizer, e.g., the SentencePiece tokenizer (Kudo et al., arXiv: 1808.06226) or another tokenizer, to divide the sequence into tokens from the vocabulary.

The output of the language model can include a “yes” token, or a “no” token, for example. The system can obtain a likelihood that the two sentence fragments do not belong to the same segment by obtaining the probability of the “no” token from a last layer of the language model. The system can use the likelihood as the classification score.

For example, in implementations where the language model is auto-regressive, the system can obtain the probability of the “no” token from the output logit vector of the language model for the last current input sequence.

As another example, for each pair of sentence fragments, the system can obtain multiple predictions from the language model for whether the two sentence fragments belong to the same segment. The system can determine the classification score for a pair of sentence fragments based on the predictions obtained from the language model. For example, the system can provide the pair of sentence fragments as input to the language model ten times, and receive ten predictions. The system can obtain a classification score for each of the predictions by obtaining the probability of the “no” token from the last layer of the language model. The system can use an average of the ten classification scores as the classification score for the pair of sentence fragments.

The language model can be a pre-trained language model that has been fine-tuned on training data that includes multiple training examples. Each training example can include an input prompt that includes a pair of sentence fragments. Each training example can also include a target answer for the pair of sentence fragments. For example, the target answer can include the prediction, for example “yes or “no,” that the two sentence fragments belong to the same segment. The target answer can have been obtained from a user, for example, as described above.

The system assigns one or more split positions based on the classification scores (340). The split positions can reflect a lowest similarity between two sentence fragments in a pair of sentence fragments, among all pairs of sentence fragments. In some implementations, the split positions that reflect the lowest similarity can have the highest classification scores among the pairs of sentence fragments. In some implementations, the system can assign the top n highest classification scores as split positions, where n is an integer greater than or equal to one. In some implementations, the system can assign split positions corresponding to classification scores over a threshold classification score.

In some implementations, the system assigns one or more split positions iteratively, for example, in a constrained greedy process. Assigning split positions based on the classification scores is described in further detail below with reference to FIG. 4.

The system combines the multiple sentence fragments back into at least two segments (350). Each segment can include one or more sentence fragments. Each segment can be defined by two boundaries, for example, a starting and an ending boundary. The boundaries for a segment can indicate which sentence fragments belong to the segment. For at least one of the at least two segments, at least one of the boundaries can be identified by one of the split positions. In some examples, the starting boundary is defined by the start of the sequence of text. In some examples, the ending boundary is defined by the end of the sequence of text. For example, referring to FIG. 2, the starting boundary for segment 152a is the start of the sequence of text, and the ending boundary is identified by split position 142a. The starting boundary for segment 152b is identified by split position 142a, and the ending boundary is identified by split position 142b. The starting boundary for segment 152c is identified by split position 142b, and the ending boundary is identified by the end of the sequence of text.

In some implementations, the system can further provide the at least two segments to a user. For example, the system can provide data representing the segments to the user through a user interface. In other implementations, the system can further provide a single segment to the user, e.g., in response to a search query.

In some implementations, the system can generate a mapping of an identifier for each of the segments to a corresponding location of the segment within the sequence of text. For example, the system can generate an identifier for each of the segments. The identifier can be a number, a title, or a summary for the segment. The system can generate the title or the summary by providing the text of the segment to a large language model, for example. The system can obtain a corresponding location for each of the segments. For example, the system can identify a page number and/or line number in the sequence of text that the segment begins on as the corresponding location. The system can thus generate a mapping that lists the identifier for each segment and the corresponding location.

In some implementations, the system can generate a summary for each of the segments. For example, for each segment, the system can provide the text of the segment to a large language model and receive a natural language summary of the content of the segment. The system can provide data representing the summary(ies) to a user.

In some implementations, the system can receive a query from a user regarding the sequence of text. The system can identify relevant segments to the query and provide the identified relevant segment(s) to the user. For example, the sequence of text may represent a contract, and the query may include a request to find indemnity clauses located in the contract. The system can process the contract to determine segments. The system can process the segments using a language model to obtain a topic or summary for each of the segments. The system can identify relevant segments to the query using the summaries for the segments. For example, the system can identify segments that include indemnity clauses using the summaries for the segments. The system can provide data representing the identified relevant segment(s) to the user.

The system can identify segments that include indemnity clauses by identifying segments that are likely to include indemnity clauses. For example, the system can process a prompt for each segment that includes the segment and a request to identify whether the segment is likely to include an indemnity clause using a language model to obtain an output identifying whether the segment is likely to include an indemnity clause. In some examples, the prompt can also include examples of indemnities or a description of indemnities. As another example, the system can process the prompt for each segment multiple times using the language model to obtain multiple outputs. The system can determine whether a segment is likely to include an indemnity clause by combining the outputs for the segment. For example, the system can determine that a segment is likely to include an indemnity clause if a majority of the outputs indicate that the segment is likely to include an indemnity clause.

As another example, the system can process a prompt for each segment that includes the segment and a request to determine the likelihood that the segment includes an indemnity clause using a language model to obtain an output identifying a likelihood that the segment includes an indemnity clause. In some examples, the prompt can also include examples of indemnities or a description of indemnities. The system can determine that a segment is likely to include an indemnity clause if the output indicates that the likelihood is greater than 50%. As another example, the system can process the prompt for each segment multiple times using the language model to obtain multiple outputs. The system can determine whether a segment is likely to include an indemnity clause by combining, e.g., averaging, the outputs for the segment. For example, the system can determine that a segment is likely to include an indemnity clause if the average of the outputs indicates that the likelihood is greater than 50%.

As another example, the system can provide the segment to a machine learning model that has been trained to generate a likelihood of indemnity score. The system can determine that a segment is likely to include an indemnity clause if the indemnity score meets a threshold indemnity score. In some examples, the threshold indemnity score can be predetermined. In some examples, the threshold indemnity score can be obtained from a user.

In some implementations, the query may include a request to generate a new sequence of text. For example, the user can provide a sequence of text that includes a large number of contracts previously written by the user. The query may include a request to generate a new indemnity clause that includes any previously written indemnity clause written by the user. The system can identify segments that include indemnity clauses as described above. The system can generate a new indemnity clause by combining the identified segments, for example, using a language model. For example, the system can provide a prompt that includes at least the identified segments and a request to generate a new indemnity clause based on the identified segments as input to the language model. The system can provide data representing the new indemnity clause to the user.

FIG. 4 is a flow chart of an example process 400 for assigning split positions. The process 400 can be performed as part of step 340 described above with reference to FIG. 3. The process 400 can be performed by a system such as the assignment engine 140 described above with reference to FIG. 1.

The system assigns the one or more split positions based on a current set of classification scores at each of multiple iterations. At the first iteration, the current set of classification scores can include the classification scores determined in step 330 of FIG. 3.

At each iteration, the system determines whether a termination condition has been met. The termination condition can be defined by a condition where all of the classification scores in the current set of classification scores are zero. In some implementations, the termination condition can be defined by a condition where all of the classification scores in the current set of classification scores are less than a threshold classification score. In some implementations, the termination condition can be defined by a condition where all of the classification scores are less than a threshold classification score. In some implementations, the termination condition can be defined by a threshold number of iterations. In some implementations, the termination condition can be defined by a threshold runtime or amount of computing resources consumed.

If the termination condition has not been met (404), the system assigns a split position (410). For example, the system can assign a split position corresponding to an index for the pair of sentence fragments with a highest classification score in the current set of classification scores. Referring to FIG. 2 as an example, the system can assign split position 142b that corresponds to the pair of sentence fragments 112h and 112i.

The system modifies the classification scores (420). For example, the system modifies the current set of classification scores by setting the highest classification score to zero. Because the index corresponding to the highest classification score has already been assigned as a split position, the highest classification score in the current set of classification scores can be set to zero.

The system identifies a first set of sentence fragments (430). The first set of sentence fragments can include one or more sentence fragments that precede the split position and have classification scores in the current set of classification scores. For example, referring to FIG. 2, the first set of sentence fragments can include sentence fragments 112a-h.

The system identifies a second set of sentence fragments (440). The second set of sentence fragments can include one or more sentence fragments that follow the split position and have classification scores in the current set of classification scores. For example, referring to FIG. 2, the second set of sentence fragments can include sentence fragments 112i-n.

For each set of the first and second set, the system identifies a respective subset of sentence fragments (450). The respective subset for the first set and the second set can define a radius of pairs of sentence fragments around the split position for which the system should not assign another split. For example, assigning a split position within the radius would result in producing a segment that is too short, or less than a threshold of tokens. For example, the tokens can include characters, subwords, or words. The threshold of tokens can be, for example, at least 10 tokens, at least 20 tokens, at least 40 tokens, at least 80 tokens, or at least 160 tokens. As an example, the respective subset can include a cumulative number of tokens greater than or equal to a threshold number of tokens. The respective subset can include one or more sentence fragments, each including a number of tokens that add up to the cumulative number of tokens. In some implementations, the respective subset can include the smallest number of sentence fragments that include a cumulative number of tokens greater than or equal to the threshold number of tokens. Referring to FIG. 2, the system can identify a subset for the first set that includes sentence fragments 112f-h. For example, sentence fragments 112h and 112g together may have less than the threshold number of tokens, but sentence fragments 112h, 112g, and 112f together may have a sufficient number of tokens. The system can identify a subset for the second set that includes sentence fragments 112i-j. For example, sentence fragment 112i may have less than the threshold number of tokens, but sentence fragments 112i and 112j together may have a sufficient number of tokens.

In some examples, the threshold number of tokens is a default number of tokens. In some examples, the threshold number of tokens is less than a maximum number of tokens, e.g., the number of tokens of the context window for a language model neural network.

For each set of the first and second set, the system modifies the classification scores (460). The system can modify the current set of classification scores by setting the classification scores corresponding to the pairs of sentence fragments in the respective subset to zero. For example, the system can set the classification scores for the pairs of sentence fragments in the subset for the first set, and the subset for the second set, to zero. Referring to FIG. 2, the system can set the classification scores for sentence fragments 112g-h and 112f-g, and the classification scores for 112i-j, to zero. The system will thus not assign split positions for pairs of sentence fragments within the radius.

For each set of the first and second set, the system updates the classification scores (470). The system can update the current set of classification scores to the classification scores for the sentence fragments of the set. That is, the system updates the current set of classification scores to include the classification scores for the sentence fragments of the first set. The system thus processes the first set (sentence fragments preceding the split position) to assign further split positions by returning to the start of the process 400. The system also updates the current set of classification scores to include the classification scores for the sentence fragments of the second set. For example, the system generates another current set of classification scores. The system thus processes the second set (sentence fragments following the split position) independently from the first set to assign further split positions by returning to the start of the process 400.

The system returns to the start of the process 400 by checking the termination condition for each current set of classification scores. If the termination condition is not met (404) for the current set of classification scores, the system performs steps 410-470.

If the termination condition has been met for the current set of classification scores, the system returns to the start of the process 400 for any other current sets of classification scores that the system has not processed.

If the termination condition has been met for all current sets of classification scores (402), the system proceeds to step 350 of FIG. 3. The system combines the sentence fragments back into segments based on the split positions assigned in steps 404-470.

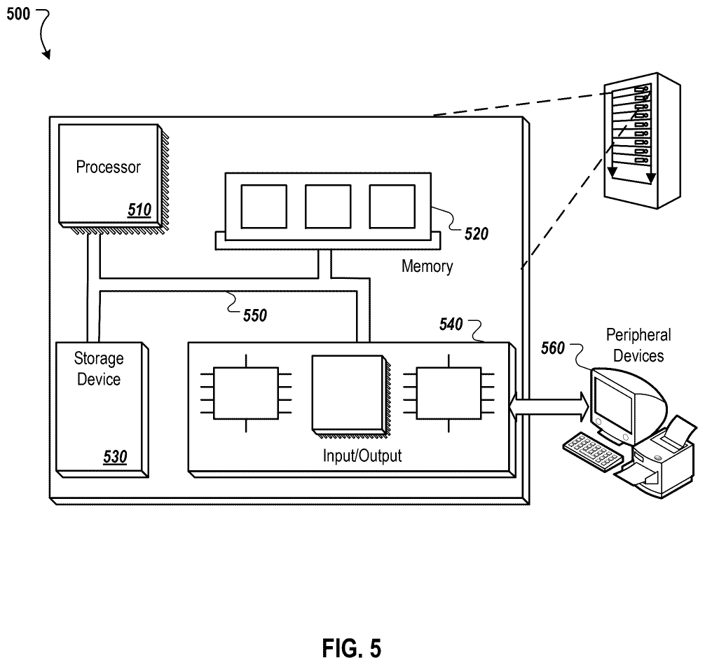

FIG. 5 depicts a schematic diagram of a computer system 500. The system 500 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 500) and their structural equivalents, or in combinations of one or more of them. The system 500 is intended to include various forms of digital computers, such as laptops, desktops, workstations, personal digital assistants, servers, blade servers, mainframes, and other appropriate computers, including vehicles installed on base units or pod units of modular vehicles. The system 500 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. The processor may be designed using any of a number of architectures. For example, the processor 510 may be a CISC (Complex Instruction Set Computers) processor, a RISC (Reduced Instruction Set Computer) processor, or a MISC (Minimal Instruction Set Computer) processor.

In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:
obtaining data representing a sequence of text;
dividing the sequence of text into a plurality of sentence fragments;
determining classification scores comprising determining a classification score using a machine learning model for each of a plurality of pairs of sentence fragments formed from the plurality of sentence fragments;
assigning one or more split positions based on the classification scores; and
combining the plurality of sentence fragments back into at least two segments, with a boundary of at least one of the at least two segments being identified by one of the one or more split positions, and wherein each segment comprises one or more sentence fragments.

Embodiment 2 is the method of embodiment 1, wherein the sequence of text represents one or more legal documents.

Embodiment 3 is the method of any of embodiments 1-2, wherein obtaining data representing a sequence of text comprises receiving the data from a user.

Embodiment 4 is the method of any of embodiments 1-3, further comprising providing the at least two segments to a user.

Embodiment 5 is the method of any of embodiments 1-4, further comprising:
receiving a query from a user;
identifying one or more relevant segments from the at least two segments; and
providing the one or more identified relevant segments to the user.

Embodiment 6 is the method of any of embodiments 1-5, wherein dividing the text into a plurality of sentence fragments comprises providing the sequence of text as input to a model that is configured to generate a plurality of sentence fragments given an input sequence of text.

Embodiment 7 is the method of any of embodiments 1-6, wherein determining a classification score using a machine learning model for each of a plurality of pairs of sentence fragments formed from the plurality of sentence fragments comprises:
for each pair of sentence fragments, determining the classification score for the pair of sentence fragments by providing data representing the pair of sentence fragments to the machine learning model, wherein the machine learning model is configured to generate a classification score representing a likelihood that an input pair of sentence fragments are not similar.

Embodiment 8 is the method of any of embodiments 1-7, wherein assigning one or more split positions based on the classification scores comprises determining one or more split positions that each reflect a highest likelihood that two sentence fragments in a particular pair of sentence fragments are not similar among the plurality of pairs of sentence fragments.

Embodiment 9 is the method of embodiment 8, wherein the one or more split positions that each reflect a highest likelihood that two sentence fragments in a particular pair of sentence fragments are not similar have a highest classification score among the plurality of pairs of sentence fragments.

Embodiment 10 is the method of any of embodiments 1-9, wherein assigning one or more split positions based on the classification scores comprises assigning one or more split positions based on a current set of classification scores at each of a plurality of iterations, and wherein the method comprises, at each iteration:
determining that a termination condition has not been met;
in response to determining that the termination condition has not been met, assigning a split position corresponding to an index for a pair of sentence fragments with a highest classification score in the current set of classification scores;
modifying the current set of classification scores by setting the highest classification score to zero;
identifying a first set of sentence fragments comprising one or more sentence fragments of the plurality of sentence fragments preceding the split position;
identifying a second set of sentence fragments comprising one or more sentence fragments of the plurality of sentence fragments following the split position;
for each set of the first set and second set:
   identifying a respective subset of sentence fragments in the set;
   modifying the current set of classification scores by setting one or more of the classification scores for the pairs of sentence fragments in the respective subset to zero; and
   updating the current set of classification scores to the classification scores for the sentence fragments of the set.

Embodiment 11 is the method of embodiment 10, wherein the respective subset of sentence fragments comprises a cumulative number of tokens greater than or equal to a threshold number of tokens.

Embodiment 12 is the method of any of embodiments 10-11, wherein the termination condition is defined by a condition where all of the classification scores are zero.

Embodiment 13 is the method of any of embodiments 1-12, wherein the machine learning model has been trained by a training system on training data, wherein the training data comprises a plurality of training examples, each comprising a training input comprising two sentence fragments and a training output comprising a label based on a user input indicating whether the two sentence fragments are similar.

Embodiment 14 is the method of embodiment 13, wherein the two sentence fragments are nonconsecutive sentence fragments.

Embodiment 15 is the method of any of embodiments 13-14, wherein the two sentence fragments are obtained from the sequence of text.

Embodiment 16 is the method of any of embodiments 1-15, wherein the machine learning model comprises a language model that has been fine-tuned on training data comprising a plurality of training examples, wherein each training example comprises an input prompt comprising a pair of sentence fragments and a target answer for the pair of sentence fragments.

Embodiment 17 is the method of any of embodiments 1-16, wherein the machine learning model comprises a classifier model.

Embodiment 18 is the method of embodiment 17, wherein the classifier model has been trained on training data comprising labeled pairs of labeled sentence fragments, wherein each pair comprises a label representing whether a first sentence fragment of the pair is similar to a second sentence fragment of the pair.

Embodiment 19 is the method of any of embodiments 1-18, further comprising generating a mapping of an identifier for each of the at least two segments to a corresponding location of the segment within the sequence of text.

Embodiment 20 is the method of any of embodiments 1-19, further comprising generating a summary for each of the at least two segments.

Embodiment 21 is a system comprising:
one or more computers; and
one or more storage devices storing instructions that, when executed by the one or more computers, cause the one or more computers to perform the method of any of embodiments 1-20.

Embodiment 22 is one or more computer-readable storage media storing instructions that when executed by one or more computers cause the one or more computers to perform the method of any of embodiments 1-20.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data representing a sequence of text;
dividing the sequence of text into a plurality of sentence fragments;
determining classification scores comprising determining a classification score using a machine learning model for each of a plurality of pairs of sentence fragments formed from the plurality of sentence fragments;
assigning one or more split positions based on the classification scores; and
combining the plurality of sentence fragments back into at least two segments, with a boundary of at least one of the at least two segments being identified by one of the one or more split positions, and wherein each segment comprises one or more sentence fragments.

2. The method of claim 1, wherein the sequence of text represents one or more legal documents.

3. The method of claim 1, wherein obtaining data representing a sequence of text comprises receiving the data from a user.

4. The method of claim 1, further comprising providing the at least two segments to a user.

5. The method of claim 1, further comprising:
receiving a query from a user;
identifying one or more relevant segments from the at least two segments; and
providing the one or more identified relevant segments to the user.

6. The method of claim 1, wherein dividing the text into a plurality of sentence fragments comprises providing the sequence of text as input to a model that is configured to generate a plurality of sentence fragments given an input sequence of text.

7. The method of claim 1, wherein determining a classification score using a machine learning model for each of a plurality of pairs of sentence fragments formed from the plurality of sentence fragments comprises:
for each pair of sentence fragments, determining the classification score for the pair of sentence fragments by providing data representing the pair of sentence fragments to the machine learning model, wherein the machine learning model is configured to generate a classification score representing a likelihood that an input pair of sentence fragments are not similar.

8. The method of claim 1, wherein assigning one or more split positions based on the classification scores comprises determining one or more split positions that each reflect a highest likelihood that two sentence fragments in a particular pair of sentence fragments are not similar among the plurality of pairs of sentence fragments.

9. The method of claim 8, wherein the one or more split positions that each reflect a highest likelihood that two sentence fragments in a particular pair of sentence fragments are not similar have a highest classification score among the plurality of pairs of sentence fragments.

10. The method of claim 1, wherein assigning one or more split positions based on the classification scores comprises assigning one or more split positions based on a current set of classification scores at each of a plurality of iterations, and wherein the method comprises, at each iteration:
determining that a termination condition has not been met;
in response to determining that the termination condition has not been met, assigning a split position corresponding to an index for a pair of sentence fragments with a highest classification score in the current set of classification scores;
modifying the current set of classification scores by setting the highest classification score to zero;
identifying a first set of sentence fragments comprising one or more sentence fragments of the plurality of sentence fragments preceding the split position;
identifying a second set of sentence fragments comprising one or more sentence fragments of the plurality of sentence fragments following the split position;
for each set of the first set and second set:
identifying a respective subset of sentence fragments in the set;
modifying the current set of classification scores by setting one or more of the classification scores for the pairs of sentence fragments in the respective subset to zero; and
updating the current set of classification scores to the classification scores for the sentence fragments of the set.

11. The method of claim 10, wherein the respective subset of sentence fragments comprises a cumulative number of tokens greater than or equal to a threshold number of tokens.

12. The method of claim 10, wherein the termination condition is defined by a condition where all of the classification scores are zero.

13. The method of claim 1, wherein the machine learning model has been trained by a training system on training data, wherein the training data comprises a plurality of training examples, each comprising a training input comprising two sentence fragments and a training output comprising a label based on a user input indicating whether the two sentence fragments are similar.

14. The method of claim 13, wherein the two sentence fragments are nonconsecutive sentence fragments.

15. The method of claim 13, wherein the two sentence fragments are obtained from the sequence of text.

16. The method of claim 1, wherein the machine learning model comprises a language model that has been fine-tuned on training data comprising a plurality of training examples, wherein each training example comprises an input prompt comprising a pair of sentence fragments and a target answer for the pair of sentence fragments.

17. The method of claim 1, wherein the machine learning model comprises a classifier model.

18. The method of claim 17, wherein the classifier model has been trained on training data comprising labeled pairs of labeled sentence fragments, wherein each pair comprises a label representing whether a first sentence fragment of the pair is similar to a second sentence fragment of the pair.

19. The method of claim 1, further comprising generating a mapping of an identifier for each of the at least two segments to a corresponding location of the segment within the sequence of text.

20. The method of claim 1, further comprising generating a summary for each of the at least two segments.

21. A system comprising:
one or more computers; and
one or more storage devices storing instructions that, when executed by the one or more computers, cause the one or more computers to perform operations comprising:
obtaining data representing a sequence of text;
dividing the sequence of text into a plurality of sentence fragments;
determining classification scores comprising determining a classification score using a machine learning model for each of a plurality of pairs of sentence fragments formed from the plurality of sentence fragments;
assigning one or more split positions based on the classification scores; and
combining the plurality of sentence fragments back into at least two segments, with a boundary of at least one of the at least two segments being identified by one of the one or more split positions, and wherein each segment comprises one or more sentence fragments.

22. One or more computer-readable storage media storing instructions that when executed by one or more computers cause the one or more computers to perform operations comprising:
obtaining data representing a sequence of text;
dividing the sequence of text into a plurality of sentence fragments;
determining classification scores comprising determining a classification score using a machine learning model for each of a plurality of pairs of sentence fragments formed from the plurality of sentence fragments;
assigning one or more split positions based on the classification scores; and
combining the plurality of sentence fragments back into at least two segments, with a boundary of at least one of the at least two segments being identified by one of the one or more split positions, and wherein each segment comprises one or more sentence fragments.
